(19) United States
(12) Patent Application Publication
(10) Pub. No.: US 2002/0191598 A1
(43) Pub. Date: Dec. 19, 2002

(54) Network switch employing free-space optical switching technique

(76) Inventor: Robert Mays JR., Austin, TX (US)

Correspondence Address: Kenneth C. Brooks, P.O. Box 10417, Austin, TX, 78766-1417, US

(21) Appl. No.: 09/884,424

(22) Filed: Jun. 19, 2001

(51) Int. Cl. H04L 12/50

(52) U.S. Cl. 370/386; 370/389

(57) ABSTRACT

A method and a device to transfer data between various ports of a network switch of the type having a switching element and a plurality of subsystems. Each of the subsystems is connected to one of the ports and has an address table, a media access controller, and a router. The router includes a destination address register. The optical switching element includes a plurality of sources of optical energy and a plurality of optical detectors. Each of the plurality of subsystems is associated with a holographic transform function. The holographic transform function associated with one of the plurality of subsystems differs from the holographic transform functions associated with the remaining subsystems.

### BACKGROUND OF THE INVENTION

The present invention relates to networked computing environments. Particularly, the present invention relates to a method and a device for employing a free-space optical switching technique for an Ethernet switching device.

The desire to share information between computing environments has resulted in the creation of several network topologies. One of the earlier topologies is a bus, or linear, network. In the linear network, each computing environment, for example a personal computer (PC), is connected to a common data bus. In this manner, each PC forms a branch of the network that has a transceiver with a unique address. Each transceiver broadcasts data in both directions along the bus so that the remaining PCs receive the data. The data that is broadcast includes address information of the destination PC, as well as source and error checking information. Each PC connected to the bus analyzes the address information to determine whether the data is intended for the PC. Were the information found to contain an address corresponding to the PC analyzing the data, then the data would be read and checked for errors, and an acknowledgment would be transmitted to the sending PC indicating that the data had been received. Were two PCs to attempt to transmit data simultaneously along the bus, transmission of data along the bus would be suspended. Each PC then waits a random amount of time, i.e., a latency period, to transmit data. The randomness of the length of the latency period for each PC reduces the likelihood of an additional transmission conflict, but also reduces the amount of data that may be transmitted.

A token-ring network is another topology employed to share information between computing environments, such as PCs. In the token-ring topology, each PC has a unique address and communicates over a bus circuit, i.e., a continuous loop of wires. A token-ring adapter is associated with each PC. The token-ring adapter facilitates communication over the bus. Specifically, an all-clear message, commonly referred to as a token, continuously propagates over the bus, periodically being read by each token-ring adapter. In the original state, the token indicates that the bus is free for transmission of data by a PC. A PC having data to transmit on the bus, referred to as an originating PC, re-writes the binary code associated with the token to indicate that the bus is in use. When re-writing the binary code, the originating PC also attaches the information to be transmitted to the token, as well as the address of the PC to which the data is sent, i.e., the receiving PC. Each token-ring adapter reads the data to determine whether the PC associated therewith is the receiving PC. Were the token-ring adapter to determine that the associated PC is the receiving PC, then the receiving PC would copy the data and continue to propagate the data along the bus. The message finally returns to the originating PC, at which time the token is returned to the initial state. A drawback with this topology is that only one data packet may be present on the bus at any given time, thereby substantially reducing the data that may be transmitted per unit time.

Another topology for sharing information between computing environments, such as PCs, is referred to as a star network. In a star network individual PCs have unique addresses and communicate with a hub, or switch. Data transmitted by the PCs includes address information, as well as the error correction code. The switch reads the address information and transmits the data to the receiving PC, with an address matching the address information. More than one PC may originate data transmission at a given time. As a result, the switch polls each PC periodically to allow information to be transmitted therebetween, thereby reducing the probability of a conflict. Further, to prevent any one PC from monopolizing the switch, the switch segments into several sub-portions and allows one sub-portion of the data to be transmitted between the switch and a PC during a given polling cycle. This sharing technique reduces the amount of data that may be transferred in a unit time.

It is desired, however, to provide a networking technique that demonstrates higher data transfer rates.

### SUMMARY OF THE INVENTION

Provided are a method and a device to transfer data between various ports of a network switch of the type having a switching element and a plurality of subsystems Each of the subsystems is connected to one of the ports and has an address table, a media access controller, and a router. The router includes a destination address register. The optical switching element includes a plurality of sources of optical energy and a plurality of optical detectors. Each of the plurality of subsystems is associated with a holographic transform function The holographic transform function associated with one of the plurality of subsystems differs from the holographic transform functions associated with the remaining subsystems. The device receives a signal containing data and network addressing information. The network addressing information includes the address of one of the plurality of ports, defining a receiving port. Under control of the router and the media access controller, one of the plurality of sources produces optical energy modulated with the data, defining modulated optical energy. The modulated optical energy is transformed by the holographic transform function associated with the receiving subsystem. The data associated with the modulated optical energy is sensed by one of the plurality of detectors and transferred to the port associated with the receiving subsystem.

### BRIEF DESCRIPTION OF THE DRAWINGS

FIG. 1 is a simplified plan view of an Ethernet switching device, in accordance with the present invention;

FIG. 2 is detailed view of a router and address table shown in FIG. 1, in accordance with the present invention;

FIG. 3 is a simplified plan view of the format of an entry of an address word stored in the address table shown in FIGS. 1 and 2, in accordance with the present invention;

FIG. 4 is simplified perspective view of an optical communication system employed in a switching element shown in FIG. 1, in accordance with the present invention;

FIG. 5 is a simplified plan view showing an apparatus for fabricating the focusing transform elements shown in FIG. 4, in accordance with the present invention;

FIG. 6 is a graphical representation showing charge distribution changes in the volume of a photosensitive sheet shown in FIG. 5, in relation to the optical energy impinging thereupon and the resulting strain in the material of the volume;

FIG. 7 is a cross-sectional view of a substrate on which the focusing transform elements discussed with respect to FIG. 4 are fabricated;

FIG. 8 is a cross-sectional view of the substrate, shown above in FIG. 7, undergoing processing, showing a photo-resist layer disposed thereon;

FIG. 9 is a cross-sectional view of the substrate, shown above in FIG. 8, undergoing processing, showing a photo-resist layer being patterned;

FIG. 10 is a cross-sectional view of the substrate, shown above in FIG. 9, undergoing processing after a first etch step;

FIG. 11 is a cross-sectional view of the substrate, shown above in FIG. 10, undergoing processing after a second etch step; and

FIG. 12 is perspective view of an array of the focusing transform elements fabricated on a photo-sheet, shown in FIG. 5.

### DETAILED DESCRIPTION OF THE INVENTION

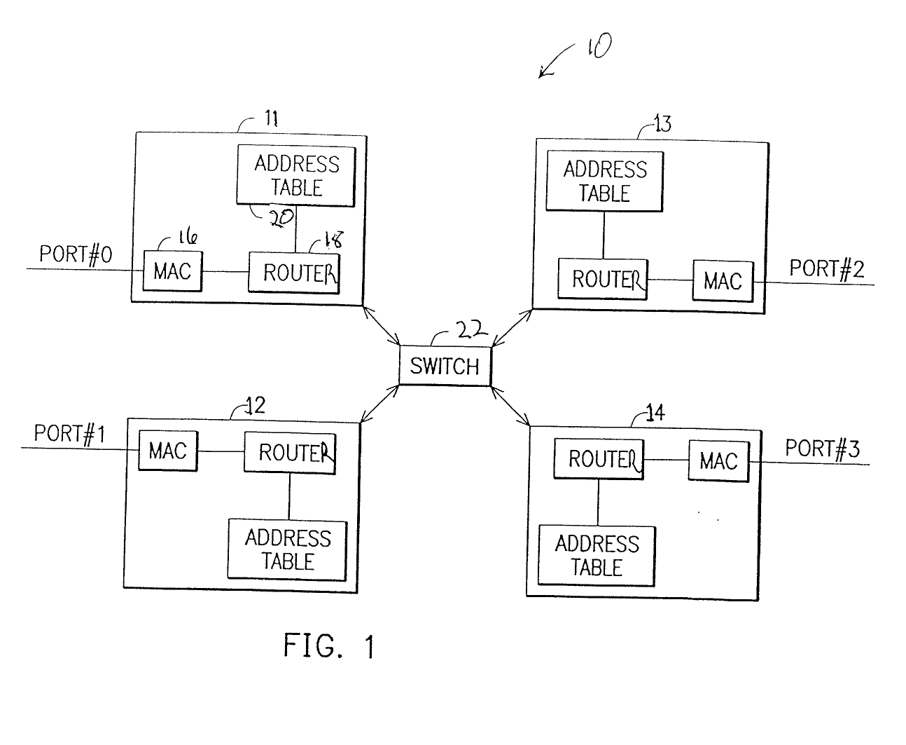

Referring to FIG. 1, a switching device 10 in accordance with one embodiment of the present invention includes four ports identified as PORT#0, PORT#1, PORT#2 and PORT#3. Switching device 10 is typically employed on a network that operates in accordance with the Ethernet protocol. As a result, the total number of ports provided by switching device 10 may be substantially greater than four. PORT#0, PORT#1, PORT#2 and PORT#3 are connected to network nodes implementing data transfer between two or more ports PORT#0, PORT#1, PORT#2 and PORT#3. To that end, switching device 10 includes subsystems 11, 12, 13 and 14, each for the corresponding one of the four ports. Each subsystem includes a set of logic, for example, subsystem 11 includes a media access controller (MAC) 16, a router 18, and an address table 20. Switching device 10 further includes a holographic switching element 22 in data communication with each subsystem 11, 12, 13, and 14. Switching element 22 facilitates data transfer between ports PORT#0-PORT#3. Essentially, MAC 16 is responsible for implementing the transmission and reception of the network data to and from the port connected thereto. Router 18, on the other hand, is used to provide the necessary control signals to holographic switching element 22 for determining which of the four ports the data should be sent to. The address table 20 is utilized to hold the information needed by the router 18 to implement data transfers.

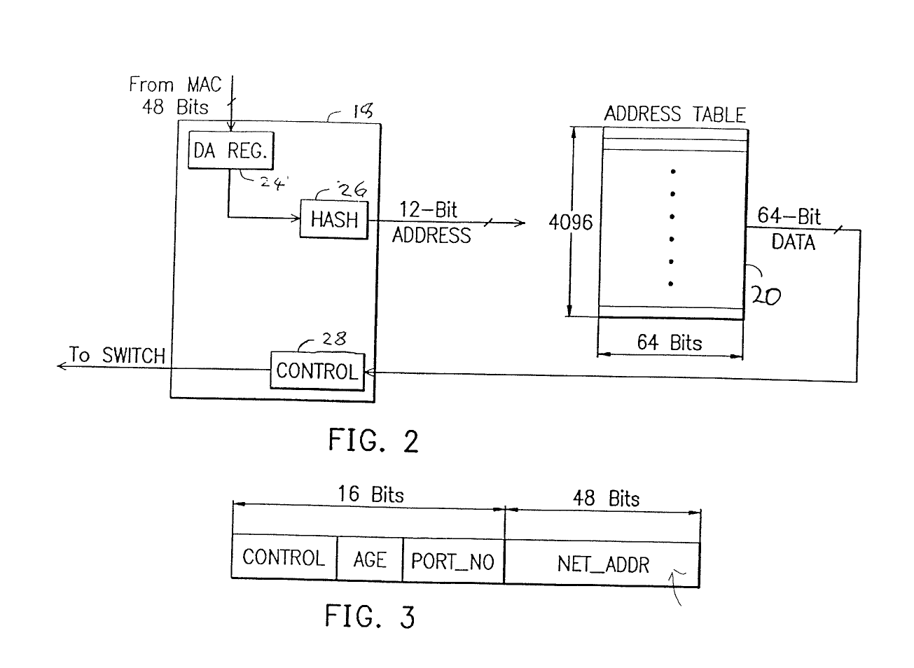

Referring to FIGS. 1 and 2, router 18 includes a destination address register (DA Reg.) 24, a hash means 26, and a control means 28. DA register 24 is a 48-bit memory device that receives and holds the destination address of the processed network data as provided by MAC 16. The destination address is relayed to hash means 26 for producing a 12-bit address that is compared with entries in address table 20.

Hash means 26 is a logic means that implements a type of compression scheme by cutting off portions of the 48-bit destination address of the processed network data. This hashing effectively reduces the size of the 48-bit destination address to a representative 12-bit address. Based on this reduced-size address information, one single corresponding 64-bit set of data can be located in address table 20, which comprises a total of, for example, 4K (4096) entries of network address information. The corresponding entry of 64-bit network address information can then be relayed back to router 18 and processed by control means 28 for its output to the holographic switching element 22.

64-bit network address information is held in address table 20, conforming to Ethernet standards, and comprising a data format such as is shown in FIG. 3. Essentially, in addition to the 48-bit network address field NET_ADDR, there is a network processing control information field CONTROL, an age information field AGE, and a port number field PORT_NO. These three information fields together take up 16 bits of the 64-bit network address information comprising the network information as depicted in the drawing.

Therefore, the 64-bit network address information entry, as retrieved from address table 20 based on the hashed 12-bit address, comprises a total of four fields, CONTROL, AGE, PORT_NO and NET_ADDR. Thus, its network address field NET_ADDR constitutes the single correspondence with the original 48-bit destination address as issued by MAC 16 of FIG. 1. This network address information retrieval from address table 20, utilizing the hashed 12-bit address, is based on the implementation of a comparison operation. The comparison is performed by comparing the 12-bit hashed address with the network address field NET_ADDR of the entries in address table 20.

When a match is produced as the result of the comparison, the corresponding 64-bit network address information can be elected and treated as the information mapped by the destination address information held in DA register 24. The other parameters contained in the other three information fields of this matched data entry, CONTROL, AGE and PORT_NO, can be used as the information for carrying out the network data routing. For example, the port number information PORT_NO can be used to determine which of the four connection ports of the device of FIG. 1 should be elected to relay the network data. As can be observed in FIG. 2, this is done by control means 28 of router 18, which relays the elected 64-bit network address information directly to holographic element 22. If, however, no conformity is found between any entry of the 4K 64-bit address table 20 and the hashed 12-bit address as issued by hash means 26, a determination is made that there is no network address having a connection tie with the current Ethernet switching device. In this case, the processed network data is broadcast to every one of the connection ports of the switching device, concurrently. The data may be broadcast concurrently to each port PORT#0, PORT#1, PORT#2 and PORT#3 without conflict due to the properties of holographic switching element 22.

Referring to FIGS. 1 and 4, holographic switching element 22 includes an array 30 of optical transmitters, shown generally as 30a-d, and an array 32 of optical detectors, shown generally as 32a-32d. Optical transmitters 30a-30d generate optical energy to propagate along a plurality of axes, and the optical detectors 32a-32d are positioned to sense optical energy propagating along one or more of the plurality of optical axes. Specifically, the array 30 is a 2×2 array of semiconductor lasers that produce a beam, which may be modulated under control of router 18 to contain information. The array 32 may comprise of virtually any optical detector known, such as charged coupled devices (CCD) or charge injection detectors (CID). In the present example, the array 32 comprises of CIDs arranged in a 2×2 array of discrete elements. The optical beam from each of the individual transmitters 30a-30d is focused to impinge upon any subportion of the detectors 32a-32d of the array 32, discussed more fully below. In this fashion, a beam sensed by one of the detectors 32a-32d of the array 32 may differ from the beam sensed by the remaining detectors 32a-32d of the array 32.

To that end, a first focusing element 34 is disposed between array 30 and array 32. Focusing element 34 includes an array of refractive lens elements 34a. Lens elements of the array 34a are arranged to match the pitch and sizing of the transmitters 30a-30d of array 30. The numerical aperture of each of the refractive lens elements of the array 34a is of sufficient size to collect substantially all of the optical energy produced by the transmitters 30a-30d corresponding thereto. In this manner, the precise alignment of each transmitter 30a-30d in array 30 with detectors 32a-32d of array 32 may be relaxed. In one example, the refractive lens elements of the array 34a are attached to the array 30, with each lens element resting adjacent to one of transmitters 30a-30d.

A second focusing element 36 is disposed between first focusing element 34 and array 32. Focusing element 36 includes an array of refractive lens elements 36a. Lens elements of the array 36a are arranged to match the pitch and sizing of the detectors 32a-32d of array 32. The numerical aperture of each of the refractive lens elements of the array 36a is of sufficient size to collect substantially all of the optical energy focused thereon by first focusing element 34 and focus said optical energy onto detectors 32a-32d. In one example, the refractive lens elements of the array 36a are attached to the array 32, with each refractive lens element of the array 36a resting adjacent to one of detectors 32a-32d.

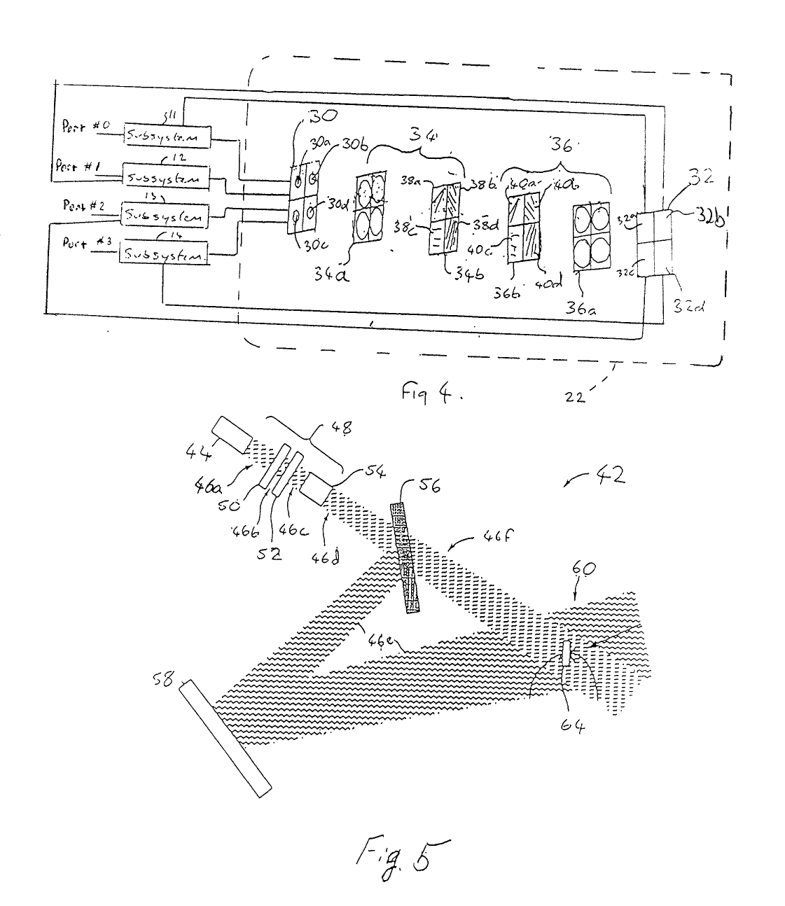

Referring to FIGS. 4 and 5, to improve channel discrimination among detectors 32a-32d, included in first and second focusing elements 34 and 36 are diffractive transform elements. Specifically, a first diffractive transform element 34b is included in first focusing element 34, and a second diffractive transform element 36b is included in focusing element 36. Each of the first and second diffractive transform elements 34b and 36b include a plurality of holographic transform functions.

As shown, first diffractive transform element 34b includes holographic transform functions 38a, 38b, 38c and 38d. Second diffractive transform element 36b includes holographic transform functions 40a, 40b, 40c and 40d. Each of the holographic transform functions 38a, 38b, 38c, 38d, 40a, 40b, 40c and 40d filter optical energy propagating therethrough by removing unwanted characteristics therefrom. The unwanted characteristics that may be removed from the optical energy include amplitude wavelength and/or polarization information by transforming the wavefront of the beam propagating therethrough, in accordance with the holographic transform function. As a result, any information contained in the energy propagating through the holographic transform function may not be sensed without the transformed wavefront being operated on by the same holographic transform function. This results from the inherent properties of holographic transform functions.

The holographic transform functions are recorded as bulk holograms and shown graphically as periodic lines for simplicity. The transform functions 38a, 38b, 38c, 38d, 40a, 40b, 40c and 40d improve channel discrimination by selectively allowing specified characteristics of the optical energy to pass therethrough and impinge upon one of the detectors 32a-32d of array 32. To that end, each holographic transform function 38a, 38b, 38c or 38d differs from the remaining holographic transform functions of diffractive transform element 34b. Similarly, each holographic transform function 40a, 40b, 40c or 40d differs from the remaining holographic transform functions of diffractive transform element 36b. However, for each of the holographic transform functions 38a, 38b, 38c and 38d of diffractive transform element 34b there is a matching holographic transform function 40a, 40b, 40c or 40d included with diffractive transform element 36b. In this manner, each of the transmitters 30a-30d of array 30 is uniquely associated to communicate with only one of the detectors 32a-32d of array 32. Thus, communication between a transmitter 30a-30d and a detector 32a-32d, referred to as a transmitter/detector pair, is achieved by having matching holographic transform functions associated with the transmitter and detector of the transmitter/detector pair.

For example, assuming that holographic transform function 38a matched holographic transform function 40a, optical energy produced by transmitter 30a would be sensed by detector 32a. In the present example, no other holographic transform functions, e.g., 40b, 40c and 40d match holographic transform function 38a. As a result, none-of the remaining detectors, i.e., 32b, 32c and 32d senses optical energy produced by transmitter 30a. Therefore, detector 32a is the only detector of array 32 capable of sensing optical energy from transmitter 30a. In this manner, each transmitter 30a-30d of array 30 is in data communication with one of the detectors 32a-32d of the array 32 that differs from the transmitters 30a-30d in data communication with remaining detectors 32a-32d of the array 32. This arrangement improves channel discrimination in switching element 22 by reducing crosstalk and improving signal-to-noise ratio.

Additional beam-sensor discrimination may be achieved by employing transmitters 30a-30d having different wavelengths or by incorporating up-conversion processes that include optical coatings applied to the individual transmitters 30a-30d or made integral therewith. One such up-conversion process is described by F. E. Auzel in “Materials and Devices Using Double-Pumped Phosphors With Energy Transfer”, Proc. of IEEE, vol. 61. no. 6, June 1973.

Referring to both FIGS. 1 and 4, each subsystem 11, 12, 13 and 14 is in electrical communication with each of transmitters 30a-30d of array 30. In this manner, each subsystem may cause each of transmitters 30a-30d to produce optical energy. Each of subsystems 11, 12, 13 and 14 is in electrical communication with one of the detectors 32a-32d of array 32, with the detector in electrical communication with one of the subsystems 11, 12, 13 and 14 being different from the detectors in electrical communication with the remaining subsystems. In this fashion, each of the subsystems 11, 12, 13 and 14 is uniquely associated with one of detectors 32a-32d or array 32. As a result, communication between ports PORT#0, PORT#1, PORT#2 and PORT#3 occurs via a matched pair of holographic transform functions 38a, 38b, 38c, 38d, 40a, 40b, 40c and 40d.

For example, data transfer from PORT#0 to PORT#2 would be achieved by having subsystem 11 activate transmitter 30c. Specifically, networking address information and data would be received on PORT#0. In response, MAC 16 and Router 18 of subsystem 11 would cause transmitter 30c to produce optical energy modulated with the data. The modulated optical energy would be transformed by holographic transform function 38c, forming transformed modulated optical energy. The refractive lens elements of the array 34a would cause the modulated optical energy to impinge upon holographic transform 40c. Holographic transform 40c would inversely transform the transformed modulated optical energy and refractive lens element 36a would focus the same onto detector, which would sense the data in the modulated optical energy. Subsystem 13 would then receive the data and transfer the same to PORT#2. Were data to be transferred from PORT#2 and PORT#0, then data transfer would occur in a similar manner, excepting that a different pair of holographic transform functions would be involved. Specifically, holographic transform functions 38a and 40a would be employed. As a result subsystem 13 would activate transmitter 30a and detector 32a would sense the data in the modulated optical energy. Subsystem 11 would then receive the data and transfer the same to PORT#0.

Referring to both FIGS. 4 and 5, each of the transform functions 38a, 38b, 38c, 38d, 40a, 40b, 40c and 40d are recorded individually as a periodic arrangement of space-charge field of material from which diffractive transform elements 34b and 36b are fabricated. For example, transform function 38a, is recorded employing a system 42 that includes a beam source 44 that directs a beam 46a into wave manipulation optics 48, such as a ¼ waveplate 50, so that a beam 46b is circularly polarized. Beam 46b impinges upon polarizer 52 so that a beam 46c propagating therethrough is linearly polarized. Beam 46c impinges upon a Faraday rotator 54 that changes birefringence properties to selectively filter unwanted polarizations from beam 46c. In this manner, a beam 46d egressing from the rotator 54 is linearly polarized. Beam 46d impinges upon a beam splitter 56 that directs a first subportion 46e of beam 46d onto a planar mirror 58. A second subportion 46f of beam 46d passes through splitter 56. The first and second subportions 46e and 46f intersect at region 60 forming an optical interference pattern that is unique in both time and space. The material from which filtering apparatus 62 is formed, photosensitive sheet 64, is disposed in the region so as to be exposed to the optical interference pattern. The interference pattern permeates the photosensitive sheet 64 and modulates the refractive index and charge distribution throughout the volume thereof. To that end, sheet 64 may be formed from any suitable photo-responsive material, such as silver halide or other photopolymers. Other materials from which sheet 64 may be formed include LiNbO₃, LiTaO₃, BaTiO₃, KnbO₃, Bi₁₂SiO₂₀, Bi₁₂GeO₂₀, PbZrO₃, PbTiO₃, LaZrO₃, or LaTiO₃.

Referring to FIGS. 4, 5 and 6, the modulation that is induced throughout the volume of the photosensitive sheet 64 is in accordance with the modulation properties of the first and second subportions 46e and 46f. A subportion of the aforementioned volume is shown as 66. A cross-section of volume 66 is shown as 68. An interference pattern, shown for simplicity as 70, is produced by beams 46e and 46f. Interference pattern 70 induces changes in refractive indices of volume 68 based on the spatial modulation of photocurrents that results from non-uniform illumination. Charges such as electrons 72, or holes, migrate within volume 68 due to diffusion and/or drift in an electric field present therein, referred to as photo-excited charges. The generation of photocurrents at low beam intensity depends on the presence of suitable donors. The photo-excited charges, which are excited from the impurity centers by interference pattern 70, are re-trapped at other locations within volume 68. This produces positive and negative charges of ionized trap centers that are re-excited and re-trapped until finally drifting out of the region of volume 68 upon which the interference pattern 70 impinges. This produces a charge distribution within volume 68, shown by curve 74. Charge distribution 74 creates a strain through volume 68, shown by curve 76 that produces regions of negative charge concentration 78 and regions of positive charge concentration 80. The resulting space-charge field between the ionized donor centers and the trapped photo-excited charges modulates the refractive indices, which is shown graphically by curve 78. As a result, the holographic transform function includes information associated with the interference pattern generated by the superposition of the first and second sub-portions 46e and 46f, such as the amplitude, phase and wavelength components of the same. This information is recorded throughout the entire bulk or volumetric thickness, v_{δ}, of sheet 64.

The volumetric thickness, v_{δ}, is defined to be the thickness required to record a complete holographic transform function. It has been determined that, for a given material, the volumetric thickness, v_{δ}, is inversely proportion to the wavelengths of first and second sub-portions 46e and 46f that create the interference pattern. A volumetric thickness, v_{δ}, as little as several microns was found suitable for recordation of a single holographic transform in the near-infrared optical frequencies. With the appropriate volumetric thickness, v_{δ}, all of the physical properties associated with the photonic or electromagnetic waves of the interference pattern, e.g., spatial and temporal (phase) aspects, wavelength, amplitude, polarization, etc. are stored in volume of sheet 64. Holographic transform functions act as a gateway to provide real-time and near real-time optical filtering.

From the foregoing it is seen that each of the holographic transform functions defined on the sheet 64 would be substantially identical. Thus, to create differing holographic transform functions, e.g., 38a, 38b, 38c, 38d, 40a, 40b, 40c and 40d, additional photosensitive sheets 64 are employed. Considering that the interference pattern is unique in both time and space, a subsequent sheet 64 disposed in region 60 would have a differing transform function recorded therein thereon than the transform function recorded on a sheet 64 at an earlier time. This is due, in part, to the time-varying fluctuations in the operational characteristics of the various components of system 42. As a result multiple sheets 64 are formed, each of which has a transform function associated therewith that differs from the transform function associated with the remaining sheets. After forming the aforementioned multiple sheets, the holographic transform functions on each of the sheets is segmented so that the same may be arranged appropriately to be positioned proximate to one or more transmitters and one or more detectors, as desired.

Alternatively, or in addition, the Faraday rotator 54 may be rotated to provide the lenses formed on the photosensitive sheet 64 with a holographic transform function that differs from the transform function associated with the lenses formed on a previous photosensitive sheet 64.

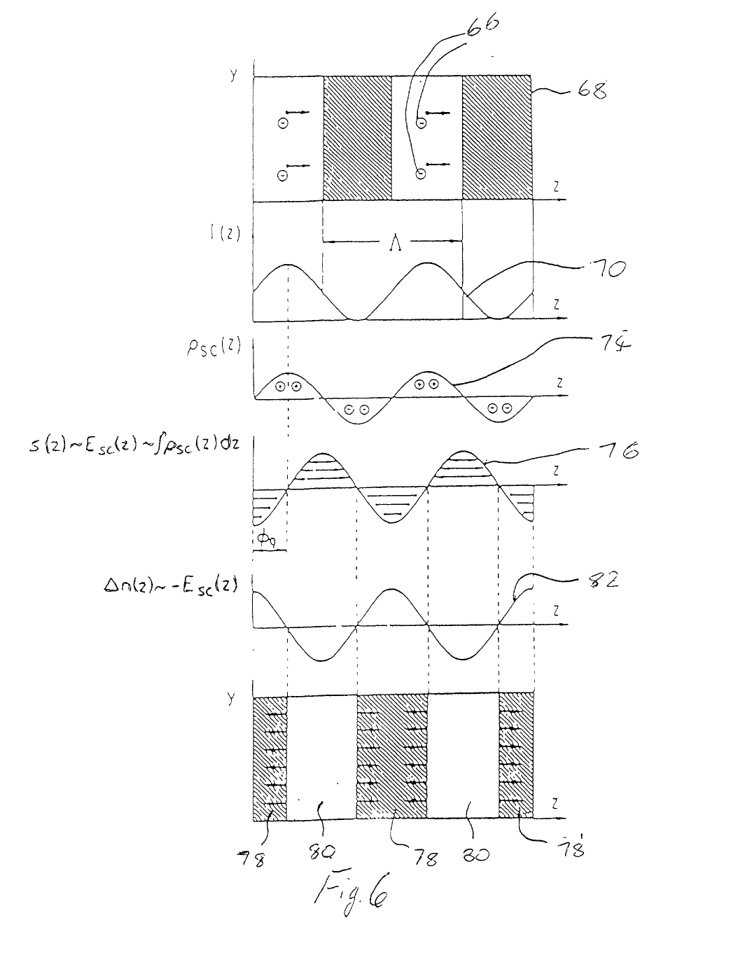

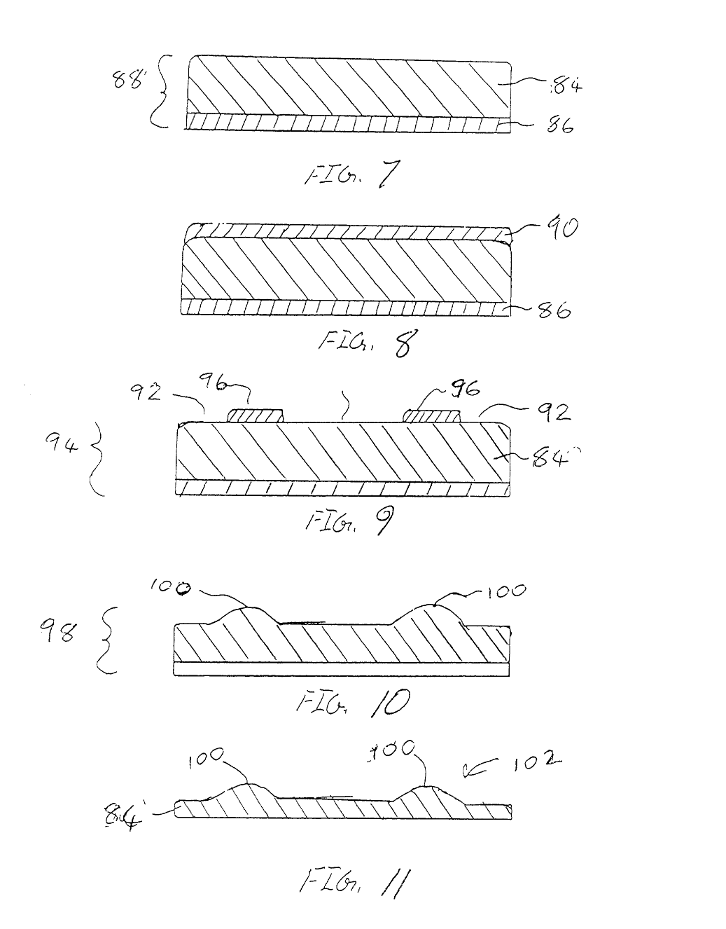

Referring to FIGS. 4 and 7, the refractive lens elements of the array 34a and the diffractive transform element 34b have been shown as two separate elements for ease of discussion. The refractive lens elements of the array 36a and the diffractive transform element 36b have also been shown as separate elements. However, refractive lens elements of the array 34a and the diffractive transform element 34b are integrally formed. Similarly, refractive lens elements of the array 36a and the diffractive transform element 36b are integrally formed. To fabricate each of focusing elements 34 and 36 to have the refractive lens and diffractive holographic transform functions, the manufacturing process of photosensitive sheet 64 includes providing a photosensitive layer 84 adhered to a sacrificial support 86, shown in FIG. 7. Examples of sacrificial layers include glass and plastic. Photosensitive layer 84 and sacrificial support 86 form a photosensitive substrate 88. Typically, photosensitive layer 84 is tens of microns thick. As shown in FIG. 8, a photo resist layer 90 is deposited onto the photosensitive layer 84 and is then patterned to leave predetermined areas exposed, shown as 92 in FIG. 9, defining a patterned substrate 94. Located between exposed areas 92 are photo resist islands 96. Patterned substrate 94 is exposed to a light source, such as ultraviolet light. This ultraviolet light darkens the volume of photo resist layer 90 that is coextensive with exposed areas 92 being darkened, i.e., become opaque to optical energy. The volume of photosensitive layer 84 that is coextensive with photo resist islands 96 is not darkened by the ultraviolet light, i.e., remaining transparent to optical energy. Thereafter, photo resist islands 96 are removed using standard etch techniques, leaving etched substrate 98, shown in FIG. 10.

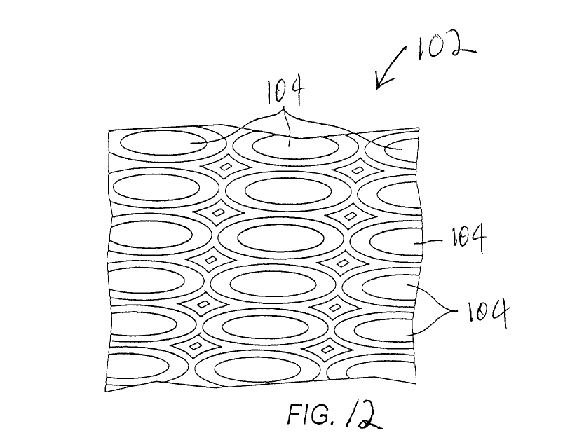

Etched substrate 98 has two arcuate regions 100 that are located in areas of the photosensitive layer 84 disposed adjacent to islands 96, shown in FIG. 11. Arcuate regions 100 of FIG. 10 result from the difference in exposure time to the etch process of the differing regions of photosensitive layer 84.

Referring to FIGS. 5, 10 and 12, a subsequent etch process is performed to form an array 102 of focusing elements 104. During this etch process the support is removed as well as nearly 50% of photosensitive layer 84 to form array 102 to be very thin. Array 102 is then placed in the system 42 and the bulk holographic transform functions are recorded in the arcuate regions 100 that define a subportion of focusing elements 34 and 36 discussed above with reference to FIG. 4. Thereafter, the focusing elements 104 may be segmented from array 102 to be included in 34 and 36.

Although the invention has been described in terms of specific embodiments, one skilled in the art will recognize that various changes to the invention may be performed, and are meant to be included herein. Therefore, the scope of the invention should not be based upon the foregoing description. Rather, the scope of the invention should be determined based upon the claims recited herein, including the full scope of equivalents thereof.

What is claimed is:

1. A method of transferring data between ports of an Ethernet switch device having a switching element and a plurality of subsystems, each of which is connected to one of said ports and has an address table, a media access controller, a router including a destination address register, said optical switching element including a plurality of sources of optical energy and a plurality of optical detectors, said method comprising:
associating each of said plurality of subsystems with a holographic transform function, with said holographic transform function associated with one of said plurality of subsystems differing from the holographic transform functions associated with the remaining subsystems;
receiving a signal containing data and network addressing information, with said network addressing information including an address of one of said plurality of ports, defining a receiving port;
producing, with one of said plurality of sources under control of said router and said media access controller, said optical energy modulated with said data, defining modulated optical energy;
transforming said modulated optical energy with said holographic transform function associated with said receiving subsystem;
sensing data associated with said modulated optical energy; and
transferring said data, as electrical signals, to the port associated with said receiving subsystem.

2. The method as recited in claim 1 wherein transforming said modulated optical energy forms transformed optical energy and sensing said data associated with said modulated optical energy further includes performing an inverse transform on said transformed optical energy, before sensing said modulated optical, to retrieve said modulated optical energy.

3. The method as recited in claim 1 further including placing in optical communication with each of said plurality of sources, a first focusing transform element having a first holographic transform function associated therewith, with the first holographic transform function associated with one of said plurality of sources being different from the first holographic transform function associated with the remaining plurality of sources and placing in optical communication with each of said plurality of detectors, a second focusing transform element having a second holographic transform function associated therewith, with the second holographic transform function associated with one of said plurality of sources being different from the second holographic transform function associated with the remaining plurality of detectors, with each of said second holographic transform functions matching one of said first holographic transform functions.

4. The method as recited in claim 1 wherein receiving a signal containing data and network addressing information further includes receiving said network address information in said destination address register and comparing a subportion of said network addressing information with information stored in said address table to ascertain to which of said plurality of ports said media access controller may transfer data.

5. The method as recited in claim 1 further including storing within said address table a plurality of network addresses, each of which being a 64-bit word including CONTROL information, AGE information, PORT_NO information and NET_ADDR information.

6. The method as recited in claim 3 wherein associating each of said plurality of subsystems with a holographic transform function, further includes placing each of said plurality of subsystems in electrical communication with all of said plurality of sources.

7. The method as recited in claim 3 wherein associating each of said plurality of subsystems with a holographic transform function, further includes placing each of said plurality of subsystems in electrical communication with one of said plurality of detectors, with the detector in electrical communication with one of said plurality of subsystems differing from the detectors in electrical communication with the remaining subsystems.

8. An Ethernet switching device, comprising:
a plurality of subsystems, each of which includes an address table, a media access controller, a router including a destination address register,
an optical switching element in data communication with each of said plurality of subsystems, said optical switching element including a plurality of holographic transform function, each of which is associated with one of said plurality of subsystems, with said holographic transform function associated with one of said plurality of subsystems differing from the holographic transform functions associated with the remaining subsystems; and
a plurality of ports, each of which is connected to one of said plurality of subsystems.

9. The method as recited in claim 8 wherein said address table further includes a plurality of network addresses, a subportion of which comprises of a 64-bit word having a structure in accordance with an Ethernet standard and including CONTROL information, AGE information, PORT_NO information and NET_ADDR information.

10. The switching device as recited in claim 8 wherein said optical switching element further includes a plurality of sources of optical energy and a plurality of optical detectors, and said plurality of transform functions are defined by first and second focusing transforms in optical communication with said plurality of sources, with said first focusing transform being in optical communication with each of said plurality of sources and having a plurality of first holographic transform functions associated therewith, with the first holographic transform function associated with one of said plurality of sources being different from the first holographic transform function associated with the remaining plurality of sources.

11. The switching device as recited in claim 10 wherein said second focusing transform further includes a plurality of second holographic transform functions, with the second holographic transform function associated with one of said plurality of detectors being different from the second holographic transform function associated with the remaining plurality of detectors, with each of said second holographic transform functions matching one of said plurality of first holographic transform functions.

12. The switching device as recited in claim 11 wherein each of said plurality of subsystems is in electrical communication with each of said plurality of optical sources.

13. The switching device as recited in claim 11 wherein each of said plurality of subsystems are in electrical communication with one of said plurality of detectors, with the detector in electrical communication with one of said plurality of subsystems differing from the detectors in electrical communication with the remaining subsystems.

14. An Ethernet switching device, comprising:
a plurality of subsystems, each of which includes an address table, a media access controller, a router including a destination address register,
an optical switching element in data communication with each of said plurality of subsystems, said optical switching element including a plurality of sources of optical energy, a plurality of optical detectors, and a plurality of holographic transform functions, each of which is associated with one of said plurality of subsystems, with said holographic transform function associated with one of said plurality of subsystems differing from th e holographic transform functions associated with the remaining subsystems;
a plurality of ports, each of which is connected to one of said plurality of subsystems; and
means for associating each of said plurality of subsystems with one of said plurality of a holographic transform functions, with said holographic transform function associated with one of said plurality of subsystems differing from the holographic transform functions associated with the remaining subsystems.

15. The switching device as recited in claim 14 further including means for producing, with one of said plurality of sources under control of said router and said media access controller, said optical energy modulated with said data, defining modulated optical energy and means for transforming said modulated optical energy with said holographic transform function associated with said receiving subsystem.

16. The switching device as recited in claim 14 wherein said address table further includes a plurality of network addresses, a subportion of which comprises of a 64-bit word having a structure in accordance with an Ethernet standard and including CONTROL information, AGE information, PORT_NO information and NET_ADDR information.

17. The switching device as recited in claim 16 further including means for comparing a subportion of said network addressing information with said plurality of addresses to ascertain to which of said plurality of ports said media access controller may transfer data.

18. The switching device as recited in claim 14 wherein said means for associating each of said plurality of subsystems with one of said plurality of a holographic transform functions further includes first and second focusing transforms in optical communication with said plurality of sources, with said first focusing transform being in optical communication with each of said plurality of sources and having a plurality of first holographic transform functions associated therewith, with the first holographic transform function associated with one of said plurality of sources being different from the first holographic transform function associated with the remaining plurality of sources and said second focusing transform further includes a plurality of second holographic transform functions, with the second holographic transform function associated with one of said plurality of detectors being different from the second holographic transform function associated with the remaining plurality of detectors, with each of said second holographic transform functions matching one of said plurality of first holographic transform functions.

19. The switching device as recited in claim 18 wherein each of said plurality of subsystems is in electrical communication with each of said plurality of optical sources.

20. The switching device as recited in claim 18 wherein each of said plurality of subsystems are in electrical communication with one of said plurality of detectors, with the detector in electrical communication with one of said plurality of subsystems differing from the detectors in electrical communication with the remaining subsystems.
